(19) United States
(12) Patent Application Publication
(10) Pub. No.: US 2022/0326990 A1
(43) Pub. Date: Oct. 13, 2022

(54) PROVIDING OPTIMIZATION IN A MICRO SERVICES ARCHITECTURE

(71) Applicant: A.P. MØLLER - MÆRSK A/S, Copenhagen K (DK)

(72) Inventors: Andrea CASSIOLI, Brønshøj (DK); Stefan Otto Theodor GUERICKE, Kongens Lyngby (DK)

(21) Appl. No.: 17/642,711

(22) PCT Filed: Sep. 21, 2020
(86) PCT No.: PCT/EP2020/076292

§ 371 Date: Mar. 14, 2022

(30) Foreign Application Priority Data
Sep. 20, 2019 (DK) PA201970581

(51) Int. Cl. G06F 9/48

(52) U.S. Cl. CPC G06F 9/4881

(57) ABSTRACT

A computer-implemented method for providing optimization in a micro services architecture comprising at least one optimization service is disclosed. The at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. The method comprises receiving (101), by the managing component, an optimization request submitted from the client comprising an optimization task and corresponding data for optimization, storing (104), by the managing component, the corresponding data for optimization and a created associated identifier of the optimization task in the at least one storage component, sending (105), by the managing component, the optimization task and the associated identifier of the optimization task to the messaging component, monitoring (106), by the at least one working component, the messaging component for received optimization tasks. The method further comprises, at detection (107), by the at least one working component, of a received optimization task, obtaining (108), by the at least one working component, through the associated identifier of the optimization task the stored corresponding data for optimization from the at least one storage component, creating (109), by the at least one working component, an optimization model to solve the optimization task, solving (110), by the at least one working component, the optimization task based on the created optimization model, and storing (111), by the at least one working component, the solution to the optimization task and the associated identifier of the optimization task in the at least one storage component. Corresponding computer program product, and architecture are also disclosed.

### TECHNICAL FIELD

The present disclosure relates generally to the field of micro services. More particularly, it relates to providing optimization in a micro services architecture.

### BACKGROUND

In contrast to monolithic applications, micro services consist of loosely coupled services providing advantages in development agility, scalability and resilience and the ability to isolate work of different teams from each other and reuse services across different projects.

A benefit of micro services is that it provides an isolated service which is much easier to develop, update and maintain by a small team.

However, utilizing micro services for different tasks also poses several drawbacks, such as data accessibility, infrastructure overhead and more complex systems.

Therefore, there is a need for alternative approaches for utilizing micro services.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other drawbacks.

According to a first aspect, this is achieved by a computer-implemented method for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other.

The method comprises receiving, by the managing component, an optimization request submitted from the client comprising an optimization task and corresponding data for optimization, storing, by the managing component, the corresponding data for optimization and a created associated identifier of the optimization task in the at least one storage component, sending, by the managing component, the optimization task and the associated identifier of the optimization task to the messaging component, and monitoring, by the at least one working component, the messaging component for received optimization tasks.

The method further comprises, at detection, by the at least one working component, of a received optimization task, obtaining, by the at least one working component, through the associated identifier of the optimization task the stored corresponding data for optimization from the at least one storage component, creating, by the at least one working component, an optimization model to solve the optimization task, solving, by the at least one working component, the optimization task based on the created optimization model, and storing, by the at least one working component, the solution to the optimization task and the associated identifier of the optimization task in the at least one storage component.

In the present context, the term “client” is to be understood as a piece of computer hardware or software that accesses the optimization service. The optimization service may be made available by a server as a part of the client-server model of computer networks. The server may be on another computer system. The client typically sends the optimization requests to the optimization service. The term “client” may also be understood as a computer or device that run a client software or users that use the client software. The client may be different from an end-user. The client may be defined by client attributes such as an IP address.

An advantage of some embodiments is that alternative approaches for utilizing micro services are provided.

Another advantage of some embodiments is that scalability and robustness of the micro services architecture, the optimization service(s), and the components thereof are ensured.

Yet an advantage of some embodiments is that the scalability reduces the risk of overload of the components, e.g. the working components, as further components may be added to the optimization service(s) to match the optimization load so that a varying demand of resources is met.

Still further, the scalability reduces the risk of the components, e.g. the working components, being idle as components may be removed from the optimization service(s) to match the optimization load so that a varying demand of resources is met.

Yet another advantage of some embodiments is that the robustness reduces the risk of a failure of the components, e.g. the working components, as one or several other component may replace the component at risk of causing a failure e.g. by taking on the workload of that component temporarily.

Yet more advantages of some embodiments are that the micro services architecture, its optimization service(s), and components thereof are easier to develop, update and maintain accordingly.

In some embodiments, the method further comprises determining, by the managing component, meta data based at least on the submitted optimization request, wherein the meta data comprises submission data of the optimization request, and storing, by the managing component, the determined meta data in the at least one storage component, wherein the at least one storage component is accessible to both the managing component and the at least one working component.

An advantage of some embodiments is that since the meta data of the optimization request is determined and separated from the data for optimization and stored accordingly, the meta data is of a data size which is predictable in contrast to the payload which may be of varying data size and provides benefits storage-wise for the optimization service e.g. in providing or selecting the appropriate or ideal storage solutions for the meta data.

Another advantage is that since the meta data annotates the optimization request, e.g. with user name and IP address of the client, the meta data provides an association of the client with the client submitted optimization request. As the optimizations are performed in a distributed system of components, the meta data provides the annotations needed for the managing component to manage the optimization requests with respect to the client e.g. in status updating, stopping, providing of solution of the optimization task to the client who submitted the optimization request.

In some embodiments, the method further comprises determining, by the managing component, payload based on the submitted optimization request, wherein the payload comprises the corresponding data for optimization, and storing, by the managing component, the determined payload in the at least one storage component, wherein the at least one storage component is accessible to both the managing component and the at least one working component.

An advantage of some embodiments is that since the payload of the optimization request is determined and separated from the meta data and stored accordingly, the stored payload can be treated as data for optimization as such since the meta data has already been separated. As the optimization is performed in a distributed system of stateless components, the separated payload provides the input for the working component without further pre-processing needed for the working component.

In some embodiments, the at least one storage component comprises a database.

An advantage of some embodiments is that a single storage, i.e. the database, in the optimization service provides the needed storage for both meta data and payload. Hence, the optimization service may be simplified further and achieve an even less complex optimization service by only implementing the single storage.

In some embodiments, the at least one storage component comprises two storage components including the database and an object storage, respectively.

An advantage of some embodiments is that the two separate storages, i.e. the database and the object storage, provide data type specific storage, i.e. the database which may store the meta data and the object storage which may store the payload wherein the object storage is data type specific for storage of large raw data which is the payload, i.e. the data for optimization, write/read data, calculation data, and is particularly efficient to store large amount of data, e.g. large binary data sets and binary large objects (BLOBS), that do not need to be (partly) updated and do not need to be modified. Blobs are collections of binary data such as images, or other multimedia objects stored as a single entity in a database management system.

In some embodiments, the database is configured to store meta data or meta data and payload of the optimization request.

An advantage of some embodiments is that the database provides storage only for the meta data and thereby the database may be reduced in size as the meta data is predictable in data size and is usually smaller in data size than the payload, hence the database is less complex and reduced in size as it is only dedicated to meta data. SQL and NoSQL databases may be used for storing the meta data. A further advantage of the database storing only the meta data is that it provides simplicity of design, simpler scaling, and finer control over availability.

An advantage of some embodiments is that the database provides the needed storage for both meta data and payload and thereby the optimization service may be simplified further and achieve an even less complex optimization service component-wise by only implementing the single storage dedicated to both meta data and payload.

In some embodiments, the meta data comprises data for annotating the optimization request.

An advantage of some embodiments is that the meta data annotates the optimization request, e.g. user name and IP address of the client, and thereby the annotation provides an association of the client with the client submitted optimization request.

In some embodiments, the object storage is configured to store payload of the optimization request.

An advantage of some embodiments is that the object storage is data type specific for storage of large raw data which is the payload, i.e. the data for optimization, and is particularly efficient to store large amount of data, e.g. large binary data sets, that do not need to be (partly) updated. Further advantage of the object storage is that it offers data scalability and security, i.e. customers of all sizes and industries can use it to store any amount of data knowing that data are protected. Yet further advantage is that the object storage provides data availability, and performance, i.e. it is easy to use and organize data and configure finely-tuned access controls to meet specific requirements. Additionally, non-structured data may be stored therein. The object storage may be a storage such as Microsoft Azure and Amazon S3.

In some embodiments, the payload comprises data for optimization corresponding to the optimization request.

An advantage of some embodiments is that the determined and separated payload provides the input for the working component without further pre-processing needed for the working component.

In some embodiments, the method further comprises updating, by the working component, a status of the optimization request in the at least one storage component.

An advantage of some embodiments is that the managing component and in turn the client is provided with correct data on the current status of the optimization request.

In some embodiments, the method further comprises querying, by the client, the status of the optimization request from the managing component, and receiving, by the client, a notification from the managing component indicative of the status of the optimization request obtained from the at least one storage component.

An optimization request may have a versatile life-cycle, transitioning from one state to another. An optimization request may transition through terminal and non-terminal states. Examples of terminal states are Invalid, Stopped, Critical, and Optimized wherein the states are final and are no longer able to transition into another state. Examples of non-terminal states are Queued, Error, and Loaded wherein the states are non-final and are still able to transition into another non-final or final state. The states may be communicated to the client by the managing component. Communicating the states to the client ensures that a feedback is provided and additionally ensures a more robust system in particular in case of unexpected errors.

An advantage of some embodiments is that the managing component and in turn the client is provided with the current status of the optimization request on request from the client.

In some embodiments, the method further comprises providing, by the managing component at request from the client, the stored solution to the optimization task with status completed to the client.

An advantage of some embodiments is that the solution is provided to the client when it has been completed and the status has been set to completed in the at least one storage component.

In some embodiments, the method further comprises stopping, by the managing component at request from the client, the servicing of the optimization task with status non-completed.

An advantage of some embodiments is that the client has the capability of stopping an optimization task which is being serviced, i.e. before being completed, and thereby freeing resources in the optimization service.

In some embodiments, the at least one optimization service is configured to solve an optimization problem.

An advantage of some embodiments is that the optimization service provide a framework directed towards the one optimization problem which enables efficiency in the micro services architecture.

In some embodiments, the at least one optimization service comprises at least two working components, wherein the at least two working components are identical instances and are configured to create the same optimization model corresponding to one optimization problem.

An advantage of some embodiments is that the working components share a common framework directed towards the same optimization problem which enables scalability and efficiency of the optimization service in the micro services architecture.

In some embodiments, the working component comprises a generic part and an optimization-specific part.

An advantage of some embodiments is that the working components to some extent may share a common generic part enabling scalability while still being configurable to create an optimization model corresponding to a specific optimization problem.

In some embodiments, the components in the at least one optimization service are stateless components. The working component may be a stateless component. When the component is stateless, an optimization service server may not store any state about the client session. Instead, the session data may be stored on the client and passed to the optimization service server as needed. Namely, session data is stored locally on the client when internet connectivity is unavailable and uploaded and replicated in the cloud when a connection becomes available or when a request for session data is received. The client may be an end user's device.

An advantage of some embodiments is that a lightweight implementation is provided wherein the components may be fired up and killed quickly.

In some embodiments, the optimization tasks are submitted by clients to the at least one optimization service in an ad-hoc manner.

An advantage of some embodiments is that a varying submission rate of optimization requests may be met.

In some embodiments, the optimization task comprises at least one optimization criterion.

An advantage of some embodiments is that the optimization task may be completed and a solution be provided accordingly.

In some embodiments, the architecture comprises a decision support system and/or an optimization system, each system utilizing a cloud infrastructure.

An advantage of some embodiments is that the cloud infrastructure provides server-less computing wherein scalability and deployment of optimization workloads is enabled.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is a micro services architecture for providing optimization, the micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other.

The architecture comprises a memory comprising executable instructions, one or more processors configured to communicate with the memory wherein the one or more processors are configured to cause receipt of, by the managing component, an optimization request submitted from the client comprising an optimization task and corresponding data for optimization, storage of, by the managing component, the corresponding data for optimization and a created associated identifier of the optimization task in the at least one storage component, sending of, by the managing component, the optimization task and the associated identifier of the optimization task to the messaging component, and monitoring of, by the at least one working component, the messaging component for received optimization tasks.

The one or more processors are further configured to cause, at detection, by the at least one working component, of a received optimization task, obtainment of, by the at least one working component, through the associated identifier of the optimization task the stored corresponding data for optimization from the at least one storage component, creation of, by the at least one working component, an optimization model to solve the optimization task, solving of, by the at least one working component, the optimization task based on the created optimization model, and storage of, by the at least one working component, the solution to the optimization task and the associated identifier of the optimization task in the at least one storage component.

An advantage of some embodiments is that alternative approaches for utilizing micro services are provided.

Another advantage of some embodiments is that scalability and robustness of the micro services architecture, the optimization service(s), and the components thereof are ensured.

Yet an advantage of some embodiments is that the scalability reduces the risk of overload of the components, e.g. the working components, as further components may be added to the optimization service(s) to match the optimization load so that a varying demand of resources is met.

Still further, the scalability reduces the risk of the components, e.g. the working components, being idle as components may be removed from the optimization service(s) to match the optimization load so that a varying demand of resources is met.

Yet another advantage of some embodiments is that the robustness reduces the risk of a failure of the components, e.g. the working components, as one or several other component may replace the component at risk of causing a failure e.g. by taking on the workload of that component temporarily.

Yet more advantages of some embodiments are that the micro services architecture, its optimization service(s), and components thereof are easier to develop, update and maintain accordingly.

In some embodiments, the one or more processors are further configured to cause determination of, by the managing component, meta data based at least on the submitted optimization request, wherein the meta data comprises submission data of the optimization request, and storage of, by the managing component, the determined meta data in the at least one storage component, wherein the at least one storage component is accessible to both the managing component and the at least one working component.

An advantage of some embodiments is that since the meta data of the optimization request is determined and separated from the data for optimization and stored accordingly, the meta data is of a data size which is predictable in contrast to the payload which may be of varying data size and provides benefits storage-wise for the optimization service e.g. in providing or selecting the appropriate or ideal storage solutions for the meta data.

Another advantage is that since the meta data annotates the optimization request, e.g. with user name and IP address of the client, the meta data provides an association of the client with the client submitted optimization request. As the optimizations are performed in a distributed system of components, the meta data provides the annotations needed for the managing component to manage the optimization requests with respect to the client e.g. in status updating, stopping, providing of solution of the optimization task to the client who submitted the optimization request.

In some embodiments, the one or more processors are further configured to cause determination of, by the managing component, payload based on the submitted optimization request, wherein the payload comprises the corresponding data for optimization, and storage of, by the managing component, the determined payload in the at least one storage component, wherein the at least one storage component is accessible to both the managing component and the at least one working component.

An advantage of some embodiments is that since the payload of the optimization request is determined and separated from the meta data and stored accordingly, the stored payload can be treated as data for optimization as such since the meta data has already been separated. As the optimization is performed in a distributed system of stateless components, the separated payload provides the input for the working component without further pre-processing needed for the working component.

In some embodiments, the at least one storage component comprises a database.

An advantage of some embodiments is that a single storage, i.e. the database, in the optimization service provides the needed storage for both meta data and payload. Hence, the optimization service may be simplified further and achieve an even less complex optimization service by only implementing the single storage.

In some embodiments, the at least one storage component comprises two storage components including the database and an object storage, respectively.

An advantage of some embodiments is that the two separate storages, i.e. the database and the object storage, provide data type specific storage, i.e. the database which may store the meta data and the object storage which may store the payload wherein the object storage is data type specific for storage of large raw data which is the payload, i.e. the data for optimization, and is particularly efficient to store large amount of data, e.g. large binary data sets, that do not need to be (partly) updated.

In some embodiments, the database is configured to store meta data or meta data and payload of the optimization request.

An advantage of some embodiments is that the database provides storage only for the meta data and thereby the database may be reduced in size as the meta data is predictable in data size and is usually smaller in data size than the payload, hence the database is less complex and reduced in size as it is only dedicated to meta data.

An advantage of some embodiments is that the database provides the needed storage for both meta data and payload and thereby the optimization service may be simplified further and achieve an even less complex optimization service component-wise by only implementing the single storage dedicated to both meta data and payload.

In some embodiments, the meta data comprises data for annotating the optimization request.

An advantage of some embodiments is that the meta data annotates the optimization request, e.g. user name and IP address of the client, and thereby the annotation provides an association of the client with the client submitted optimization request.

In some embodiments, the object storage is configured to store payload of the optimization request.

An advantage of some embodiments is that the object storage is data type specific for storage of large raw data which is the payload, i.e. the data for optimization, and is particularly efficient to store large amount of data, e.g. large binary data sets, that do not need to be (partly) updated.

In some embodiments, the payload comprises data for optimization corresponding to the optimization request.

An advantage of some embodiments is that the determined and separated payload provides the input for the working component without further pre-processing needed for the working component.

In some embodiments, the one or more processors are further configured to cause update, by the working component, of a status of the optimization requests in the at least one storage component.

An advantage of some embodiments is that the managing component and in turn the client is provided with correct data on the current status of the optimization request.

In some embodiments, the one or more processors are further configured to cause query, by the client, of the status of the optimization request from the managing component, and reception, by the client, of a notification from the managing component indicative of the status of the optimization request obtained from the at least one storage component.

An advantage of some embodiments is that the managing component and in turn the client is provided with the current status of the optimization request on request from the client.

In some embodiments, the one or more processors are further configured to cause provision, by the managing component at request from the client, of the stored solution to the optimization task with status completed to the client.

An advantage of some embodiments is that the solution is provided to the client when it has been completed and the status has been set to completed in the at least one storage component.

In some embodiments, the one or more processors are further configured to cause stopping, by the managing component at request from the client, of the servicing of the optimization task with status non-completed.

An advantage of some embodiments is that the client has the capability of stopping an optimization task which is being serviced, i.e. before being completed, and thereby freeing resources in the optimization service.

In some embodiments, the at least one optimization service (310) is configured to solve an optimization problem.

An advantage of some embodiments is that the optimization service provide a framework directed towards the one optimization problem which enables efficiency in the micro services architecture.

In some embodiments, the at least one optimization service comprises at least two working components, wherein the at least two working components are identical instances and are configured to create the same optimization model corresponding to one optimization problem.

An advantage of some embodiments is that the working components share a common framework directed towards the same optimization problem which enables scalability and efficiency of the optimization service in the micro services architecture.

In some embodiments, the working component comprises a generic part and an optimization-specific part.

An advantage of some embodiments is that the working components to some extent may share a common generic part enabling scalability while still being configurable to create an optimization model corresponding to a specific optimization problem. An optimization model may comprise a mathematical model and/or a data-structure that is used to run an optimization through. The optimization model may tackle a number of mathematical optimization classes such as linear programming, mixed integer programming, non-linear optimization, constrained optimization, etc., and may be used in various fields such as critical path analysis or project planning, Floor planning, i.e. designing the layout of equipment in a factory or components on a computer chip to reduce manufacturing time, network optimization, resource allocation problems, facility location, assignment Problems, etc.

In some embodiments, the components in the at least one optimization service are stateless components.

An advantage of some embodiments is that a lightweight implementation is provided wherein the components may be fired up and killed quickly.

In some embodiments, the optimization tasks are submitted by clients to the at least one optimization service in an ad-hoc manner.

An advantage of some embodiments is that a varying submission rate of optimization requests may be met.

In some embodiments, the optimization task comprises at least one optimization criterion.

An advantage of some embodiments is that the optimization task may be completed and a solution be provided accordingly.

In some embodiments, the architecture comprises a decision support system and/or an optimization system, each system utilizing a cloud infrastructure.

An advantage of some embodiments is that the cloud infrastructure provides server-less computing wherein scalability and deployment of optimization workloads is enabled.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2a is a sequence diagram illustrating example sequence steps according to some embodiments;

FIG. 2b is a sequence diagram illustrating example sequence steps according to some embodiments;

FIG. 2c is a sequence diagram illustrating example sequence steps according to some embodiments;

FIG. 2d is a sequence diagram illustrating example sequence steps according to some embodiments;

FIG. 2e is a sequence diagram illustrating example sequence steps according to some embodiments;

FIG. 2f is a state diagram illustrating example states according to some embodiments;

FIG. 3 is a schematic block diagram illustrating an example architecture according to some embodiments;

FIG. 4 is a schematic block diagram illustrating an example arrangement according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, micro services pose several drawbacks, such as data accessibility, infrastructure overhead and more complex systems.

It is an object of some embodiments to solve or mitigate, alleviate, or eliminate at least some of the above or other drawbacks.

In the following, embodiments will be presented where alternative approaches for utilizing micro services are described.

More specifically, the presented embodiments describe technologies related to optimization in a micro services architecture.

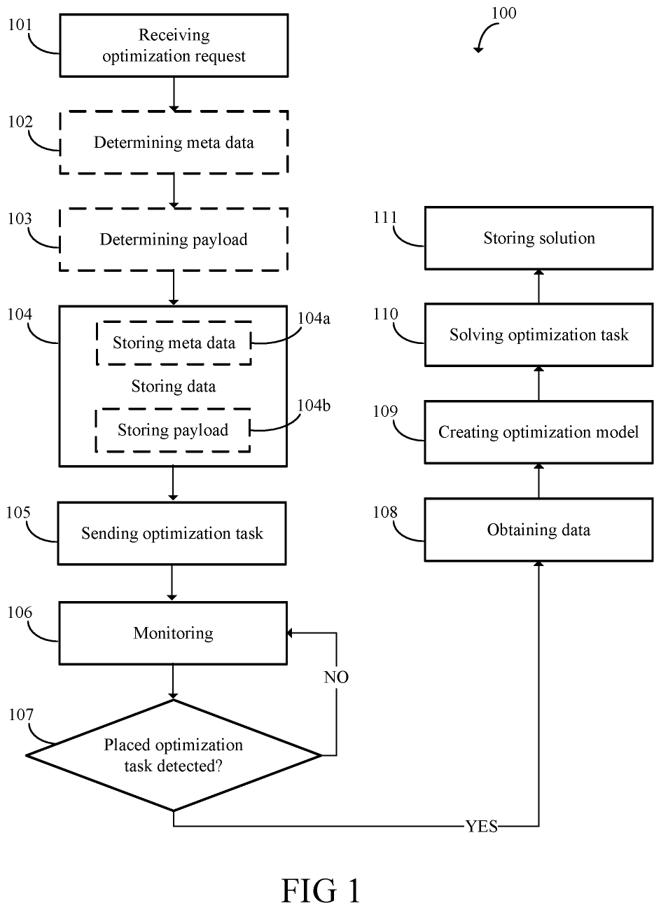

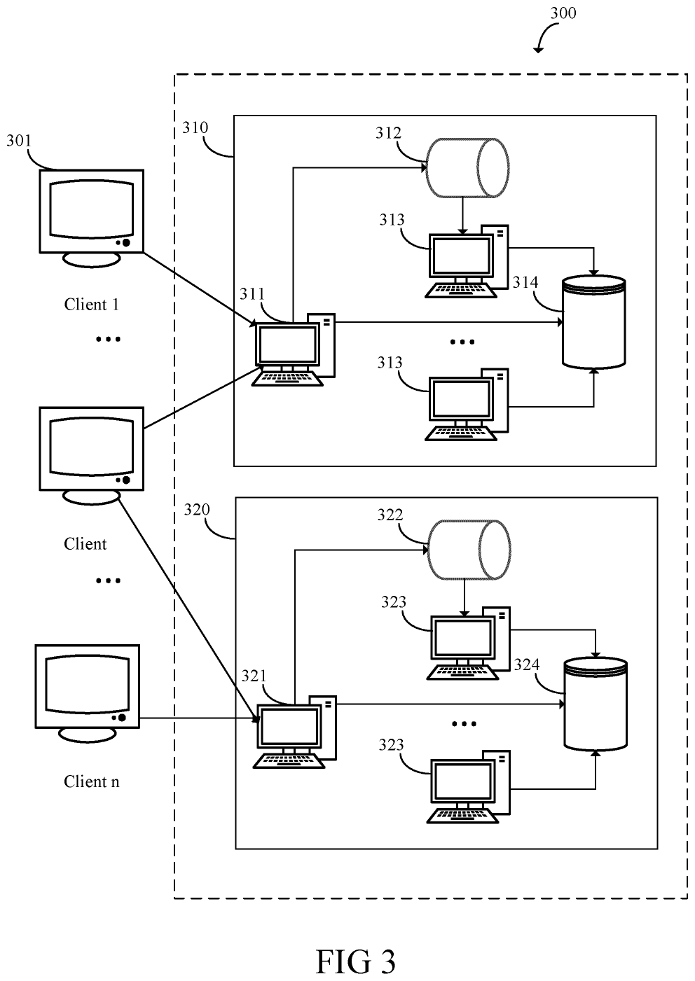

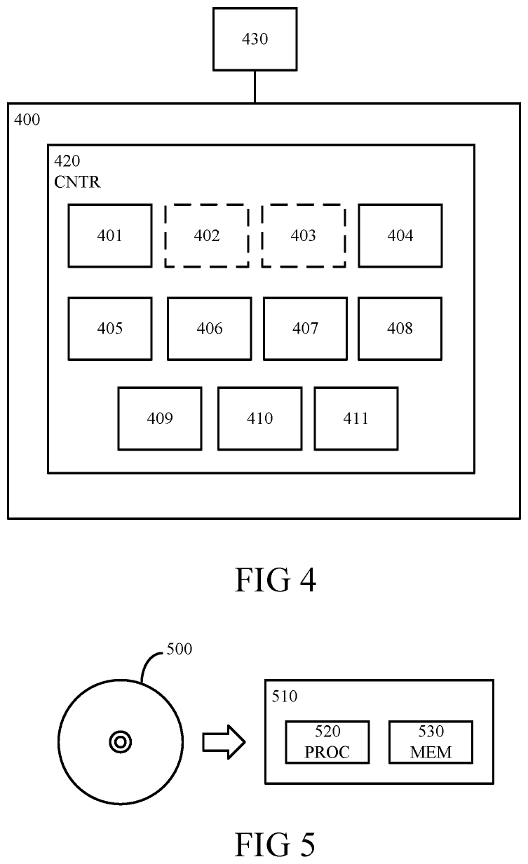

FIG. 1 is a flowchart illustrating method steps of an example optimization method 100 according to some embodiments. The optimization method 100 is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the optimization method 100 may, for example, be performed by the architecture 300 of FIG. 3 and/or the arrangement 400 of FIG. 4 and/or the computer program product 500 of FIG. 5.

The optimization method 100 comprises the following steps.

In step 101, an optimization request, submitted from a client, comprising an optimization task and corresponding data for optimization is received by the managing component.

Alternatively or additionally, the reception of the optimization request may comprise receiving and/or accepting the optimization request.

Alternatively or additionally, the optimization requests may be submitted by clients to the at least one optimization service in an ad-hoc manner, wherein the ad-hoc manner comprises use-initiated optimization in contrast to scheduled jobs running automatically.

In step 102, in some embodiments, meta data based at least on the submitted optimization request is determined by the managing component. The meta data comprises submission data of the optimization request.

For example, the determined meta data may comprise user name, date and time etc.

Alternatively or additionally, meta data comprises data for annotating the optimization request wherein annotating comprises defining the optimization request and identifying the client submitting the optimization request e.g. with user name and IP address of the client.

In step 103, in some embodiments, payload based on the submitted optimization request is determined by the managing component. The payload comprises the corresponding data for optimization.

In step 104, the corresponding data for optimization and a created associated identifier of the optimization task is stored by the managing component in the at least one storage component.

In step 104a, in some embodiments, the determined meta data is stored by the managing component in the at least one storage component, wherein the at least one storage component is accessible to both the managing component and optionally the at least one working component.

In step 104b, in some embodiments, the determined payload is stored by the managing component in the at least one storage component, wherein the at least one storage component is accessible to both the managing component and the at least one working component.

In step 105, the optimization task and the associated identifier of the optimization task is sent by the managing component to the messaging component.

Alternatively or additionally, the sending of the optimization task and the associated identifier may comprise placing the optimization task and the associated identifier in a queue in the messaging component.

In step 106, the messaging component is monitored by the at least one working component for received optimization tasks.

In step 107, a received optimization task is either detected by the at least one working component whereby the method continues to step 108 (YES-path out of step 107), or not whereby the method returns to step 106 (NO-path out of step 107).

In step 108, the stored corresponding data for optimization is obtained by the at least one working component from the at least one storage component through the associated identifier of the optimization task.

Alternatively or additionally, additional data for optimization, e.g. based on the information in the payload, may be fetched by the at least one working component to formulate the optimization problem.

For example, the corresponding data for optimization may provide one or more references for additional data to be fetched accordingly.

For example, the at least one working component may fetch the additional data for the optimization task from application programming interfaces (API), databases or other storage systems.

In step 109, an optimization model to solve the optimization task is created by the at least one working component.

Alternatively or additionally, an optimization model may comprise a mathematical model and/or a data-structure that is used to run an optimization through.

For example, the optimization model may comprise an algorithm finding the best or a good outcome to a decision problem.

For example, the creation of the optimization model may comprise specifying a mathematical model for solving, e.g. in step 110, wherein the solving may be performed though a commercial or open-source solver or a heuristic.

In step 110, the optimization task is solved based on the created optimization model by the at least one working component.

For example, the optimization task is solved by applying an algorithm to the created optimization model by the at least one working component.

In step 111, the solution to the optimization task and the associated identifier of the optimization task is stored in the at least one storage component by the at least one working component.

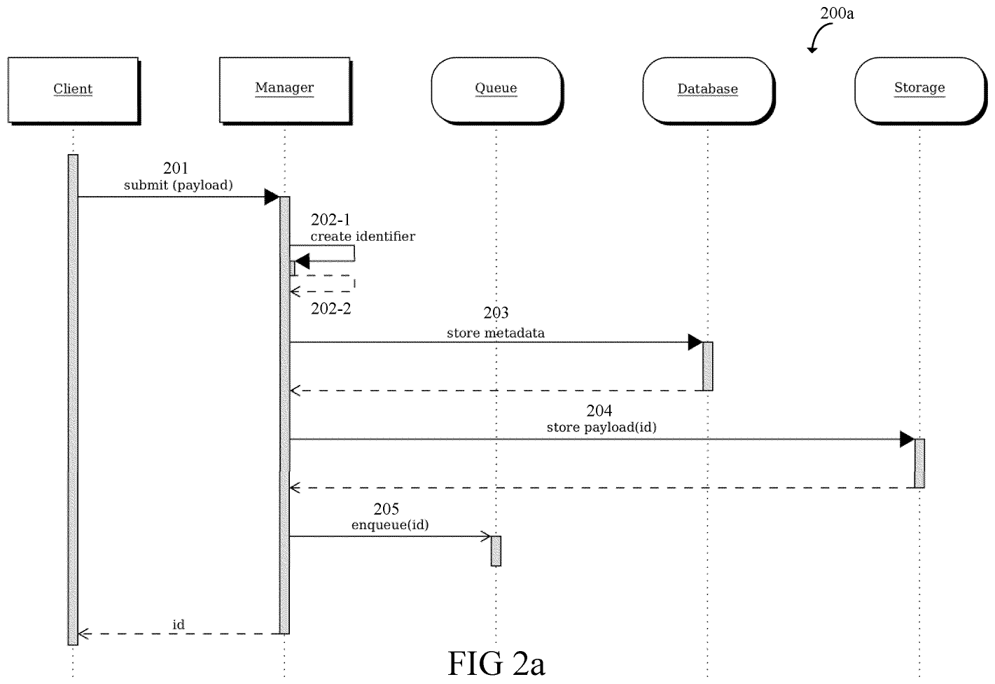

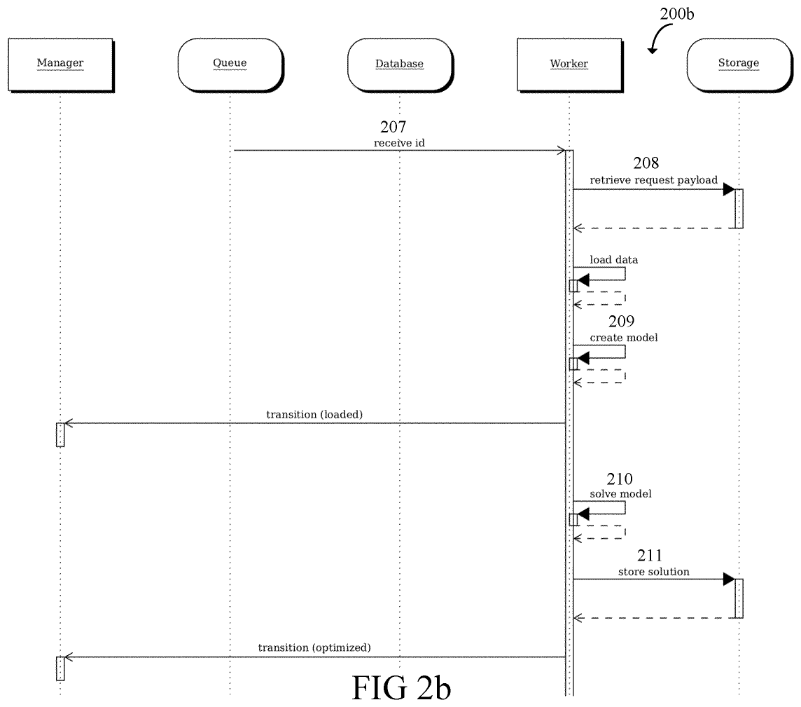

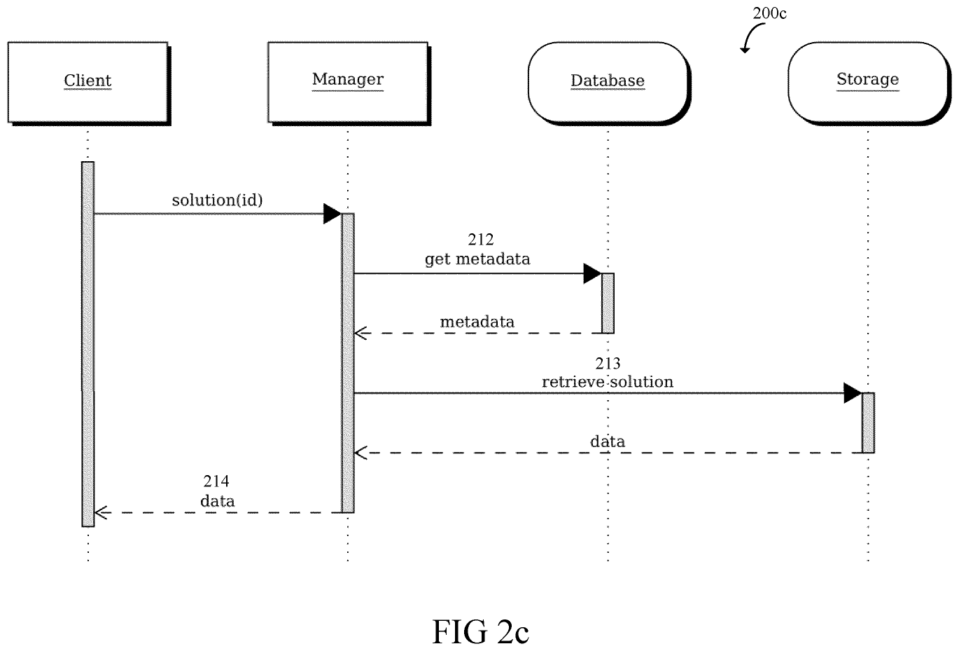

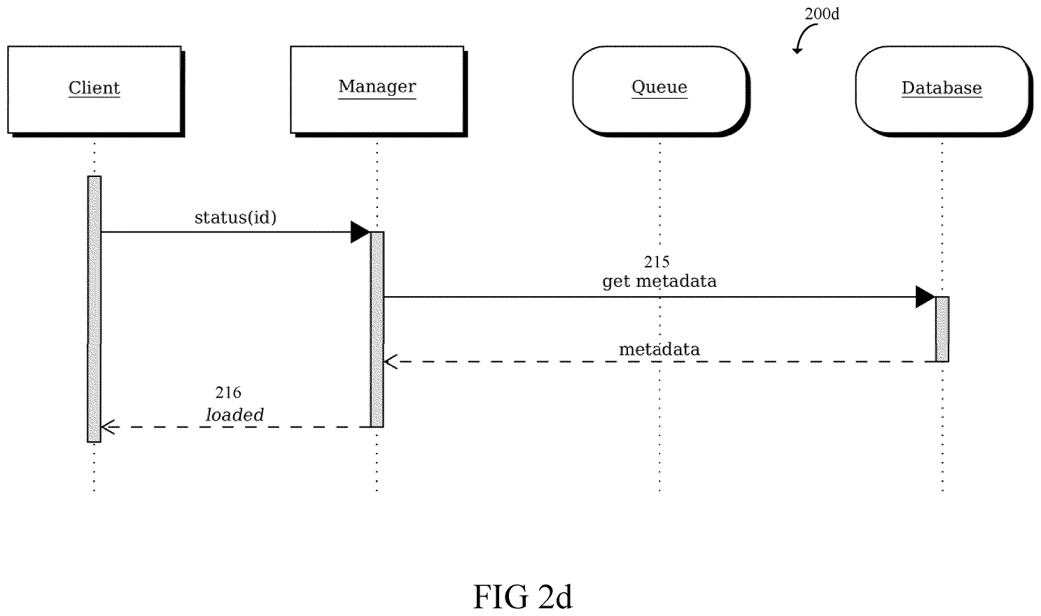

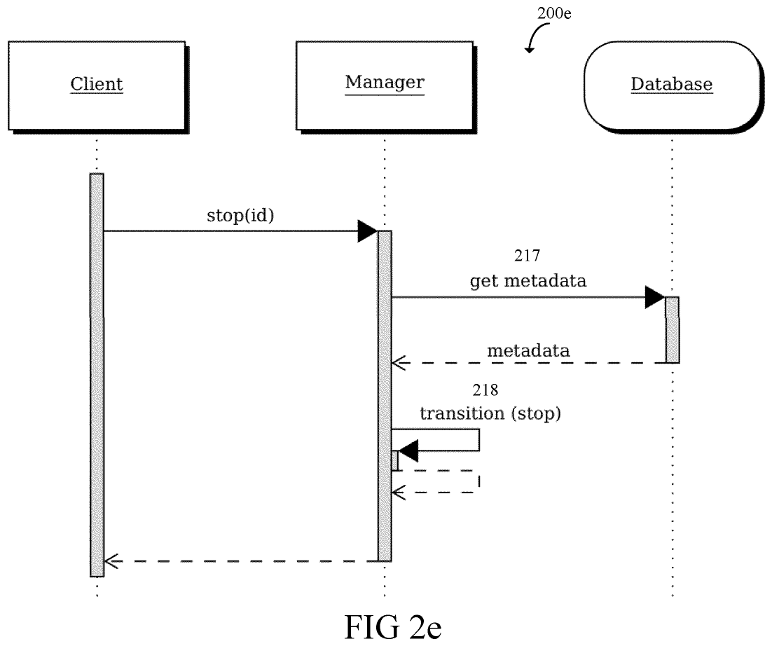

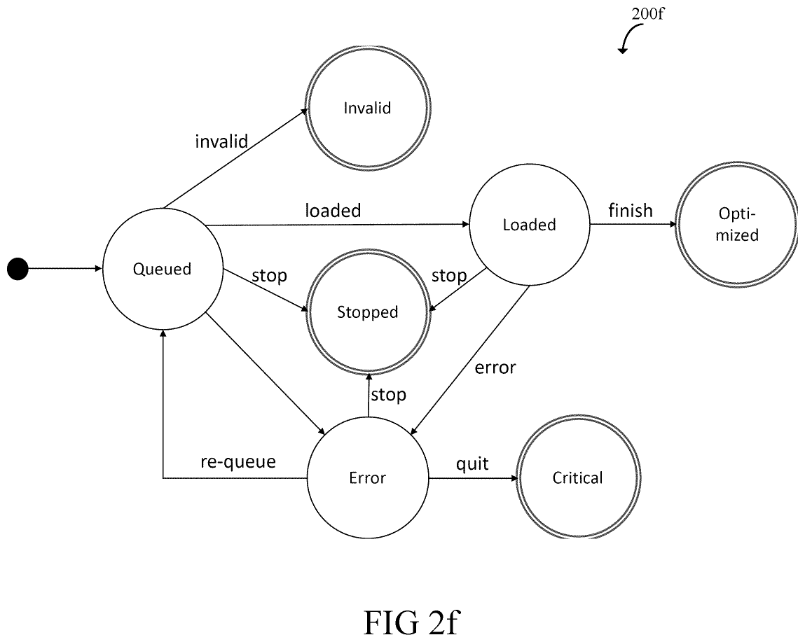

FIG. 2a is a sequence diagram illustrating some sequence steps of an example optimization sequence 200a according to some embodiments. The optimization sequence 200a is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the optimization sequence 200a may, for example, be performed by the architecture 300 of FIG. 3 and/or the arrangement 400 of FIG. 4 and/or the computer program product 500 of FIG. 5.

The optimization sequence 200a comprises following steps;

In step 201, corresponding to step 101 of FIG. 1, an optimization request, submitted from a client, comprising an optimization task and corresponding data for optimization is received by the managing component Manager.

For example, the corresponding data for optimization, i.e. the payload, can be of various format and size depending on the use-case e.g. it can be either a reference to existing data (such as a scenario identifier), a user configuration of the optimization, the entire instance for the optimization or a combination of the three. Each option has different advantages and disadvantages and trade-offs, such as size of the payload, availability to the client and accessibility to internal identifiers.

In step 202-1, an associated identifier of the optimization task is created by the managing component Manager. The associated identifier comprises identification data of the optimization request.

For example, the created identifier may comprise a globally unique identifier.

In step 202-2, corresponding to step 102 of FIG. 1, meta data based at least on the submitted optimization request is determined by the managing component Manager. The meta data comprises submission data of the optimization request.

Alternatively or additionally (not shown), corresponding to step 103 of FIG. 3, payload based on the submitted optimization request is determined by the managing component Manager. The payload comprises the corresponding data for optimization.

In step 203, corresponding to step 104a of FIG. 1, the determined meta data is stored by the managing component Manager in the at least one storage component Database, wherein the Database is accessible to both the managing component Manager and optionally the at least one working component Worker.

In step 204, corresponding to step 104b of FIG. 1, the determined payload is stored by the managing component Manager in the at least one storage component Storage (Object Storage), wherein the at least one storage component Storage is accessible to both the managing component Manager and the at least one working component Worker.

In step 205, corresponding to step 105 of FIG. 1, the optimization task and the associated identifier of the optimization task is sent by the managing component Manager to the messaging component Queue.

Alternatively or additionally, when the optimization task is queued, the optimization task is acknowledged to the client and the associated identifier is returned to the client so that the client can use it to refer to his optimization task later on.

FIG. 2b is a sequence diagram illustrating some sequence steps of an example optimization sequence 200b according to some embodiments. The optimization sequence 200b is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the optimization sequence 200b may, for example, be performed by the architecture 300 of FIG. 3 and/or the arrangement 400 of FIG. 4 and/or the computer program product 500 of FIG. 5.

The optimization sequence 200b comprises following steps;

In step 207, corresponding to steps 106 and 107 of FIG. 1, the messaging component Queue, is monitored by the at least one working component Worker for received optimization tasks and at detection of a received optimization task, the working component Worker receives the associated identifier of the received optimization task.

Alternatively or additionally, the working component Worker is responsible for running optimizations and subscribes to a queue in the messaging component Queue to which the managing component Manager populates with new optimization requests, also called messages. If multiple working components Workers, i.e. instances of worker component, are running, the messaging component Queue selects a working component based on a load-balancing mechanism e.g. round-robin.

In step 208, corresponding to step 108 of FIG. 1, the stored corresponding data for optimization is obtained, i.e. retrieved and loaded by the at least one working component Worker, from the at least one storage component Storage (Object Storage) through the associated identifier of the optimization task.

Alternatively or additionally, the working component Worker may load additional data for the optimization task from APIs, databases or other storage systems.

In step 209, corresponding to step 109 of FIG. 1, an optimization model to solve the optimization task is created by the at least one working component Worker.

Alternatively or additionally, when the stored corresponding data for optimization is obtained and the optimization model to solve the optimization task is created, the obtainment of data and creation of the optimization model is announced or published to the client.

In step 210, corresponding to step 110, the optimization task is solved based on the created optimization model by the at least one working component Worker.

For example, the data for optimization is transformed wherein this may comprise building the mathematical model in a programming framework, solver specific libraries, or data structures used for (meta) heuristics.

In step 211, corresponding to step 111, the solution to the optimization task and the associated identifier of the optimization task is stored in the at least one storage component Storage (Object Storage) by the at least one working component Worker.

Alternatively or additionally, when the solution to the optimization task and the associated identifier of the optimization task is stored, the stored solution and the new state is announced or published to the managing component Manager.

FIG. 2c is a sequence diagram illustrating some sequence steps of an example optimization sequence 200c according to some embodiments. The optimization sequence 200c is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the optimization sequence 200c may, for example, be performed by the architecture 300 of FIG. 3 and/or the arrangement 400 of FIG. 4 and/or the computer program product 500 of FIG. 5.

The optimization sequence 200c comprises following steps;

In step 212, the managing component Manager checks the status of the optimization task, at initiation of the client, e.g. by the client polling the managing component Manager, providing the associated identifier of the optimization task, through querying the at least one storage component Database of the status of the optimization task.

Alternatively or additionally, when the solution to the optimization task and the associated identifier of the optimization task is stored in the at least one storage component Storage (Object Storage), this may be acknowledged to the client so that the client can retrieve, e.g. download, the stored solution from the at least one storage component.

For example, the client may use different approaches for checking the status of a request, either long-polling or asynchronously, wherein long-polling typically blocks the client (e.g. a website) and displays some indication that the optimization is in progress whereas asynchronously refers to the user checking for the update.

Alternatively or additionally, an optional message may be added to the status comprising the date and time of when the state was set.

In step 213, when the status of the optimization task is ‘Optimized’, the solution is retrieved, e.g. fetched, by the managing component Manager from the at least one storage component Storage (Object Storage).

In step 214, the retrieved solution is provided to the client by the managing component Manager.

Alternatively or additionally, instead of providing the retrieved solution to the client and URL to the solution comprising the raw data in the at least one storage component Storage (Object Storage) e.g. by creating a request-specific access-token and providing it together with the URL and thereby only the client has the information to access and download the stored solution.

FIG. 2d is a sequence diagram illustrating some sequence steps of an example optimization sequence 200d according to some embodiments. The optimization sequence 200d is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the optimization sequence 200d may, for example, be performed by the architecture 300 of FIG. 3 and/or the arrangement 400 of FIG. 4 and/or the computer program product 500 of FIG. 5.

The optimization sequence 200d comprises following steps;

In step 215, the managing component Manager checks the status of the optimization task, at initiation of the client providing the associated identifier of the optimization task, through querying the at least one storage component Database of the status of the optimization task.

In step 216, the status of the optimization task is determined and an acknowledgement comprising the new status is sent to the client.

Alternatively or additionally, a client can query the status of an optimization task by the managing component Manager checking the current status of the optimization status.

FIG. 2e is a sequence diagram illustrating some sequence steps of an example optimization sequence 200e according to some embodiments. The optimization sequence 200e is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the optimization sequence 200e may, for example, be performed by the architecture 300 of FIG. 3 and/or the arrangement 400 of FIG. 4 and/or the computer program product 500 of FIG. 5.

The optimization sequence 200e comprises following steps;

In step 217, the managing component Manager checks the status of the optimization task, at initiation of the client providing the associated identifier of the optimization task, through querying the at least one storage component Database of the status of the optimization task.

In step 218, when the status of the optimization task is not in a terminal state e.g. ‘Invalid’, ‘Stopped’, ‘Critical’, and ‘Optimized’, the processing of the optimization task is stopped by the managing component Manager.

Alternatively or additionally, a client can stop the processing of an optimization task by the managing component Manager checking the current status of the optimization status.

FIG. 2f is a state diagram illustrating some states of the example optimization sequences 200a, 200b, 200c, 200d, and 200e according to some embodiments. The state diagram 200f illustrates states of an optimization request and their transition. The state diagram 200f illustrates a life-cycle for an optimization request, visualized as a state machine. The presented states are a minimum version and more detailed states can be introduced if necessary for a specific use-case.

Examples of terminal states are Invalid, Stopped, Critical, and Optimized wherein the states are final and are no longer able to transition into another state.

Examples of non-terminal states are Queued, Error, and Loaded wherein the states are non-final and are still able to transition into another non-final or final state.

When an optimization request is submitted successfully, it's state is set to Queued by the managing component, indicating that it will be picked up by a working component. Once the optimization request is picked up by a working component, the data is loaded from its sources (e.g. directly from the input data, other APIs, databases or data-stores) and prepared for optimization. This can e.g. include setting up the mathematical model in a framework or initializing a heuristic. Its state is set to Loaded by the working component. Thus, in case any issue occurs while loading the data, the state can transition into Error and Queued again. Once the optimization finishes and the solution has been stored, its status is set to Optimized and the managing component can return the stored solution to the client upon request. If the client stops the request, the non-terminal status is Stopped and no further state changes are performed.

When the working component recognizes invalid input data (for instance a wrong format), the state is set to Invalid to indicate a user-specific error. Expected or unexpected errors can occur while optimizing a request. Those errors lead to state Error. Depending on the use-case and/or the exception, the system may attempt to re-queue the request after some time to wait until the error is fixed. However, eventually, it reaches the state Critical if no solution was found after several tries, indicating that no further actions will be taken by the optimization service.

Overall, an optimization request results in one of the terminal states Optimized, Stopped, Invalid or Critical if at least one worker is available and the solution method is finite. It is critical for the client to rely on the optimization service to end in one of these states to function correctly. Communicating the states to the client ensures that a feedback is provided and additionally ensures a more robust system also in case of unexpected errors.

FIG. 3 is a schematic block diagram illustrating components of an example micro services architecture 300 according to some embodiments. The micro services architecture 300 is for providing optimization, the micro services architecture comprising at least one optimization service 310 wherein the at least one optimization service 310 comprises a managing component 311 configured to provide access to the at least one optimization service 310 to a client 1, a messaging component 312 configured to queue optimization requests, at least one working component 313 configured to solve optimization tasks, and at least one storage component 314, and wherein the components 311, 312, 313, 314 in the at least one optimization service 310 are operatively connected to each other. Thus, the micro services architecture 300 may, for example, perform the method steps of FIG. 1, the sequence steps of any of FIGS. 2a-2e, and set the states of FIG. 2f for any optimization task submitted to the micro services architecture 300.

The micro services architecture 300 is for providing optimization, wherein the optimization may comprise mathematical optimization as a web-service solving a specific optimization problem.

The micro services architecture 300 may be referred to as Optimization as a Service (OaaS) and reflects the micro services approach to a single optimization use case that can be utilized from several applications.

Optimizations as described herein may comprise software services or web interfaces wherein optimizations can be delivered to consumers fast.

Components as described herein comprise of independent software processes that can be developed and tested independently, are loosely coupled and interact through network communication and/or shared storage.

For example, the components can be developed and tested independently and in different programming languages and platforms.

Stateless components as described herein comprise components which do not retain its own state but are mere components configured to perform a function and return a result enabling memory savings and clean, simple implementations, and identical working components.

The micro services architecture 300 is based on:
at least one optimization service comprising stateless components;
the at least one optimization service 310 addressing one specific optimization use-case; and
executing optimizations in an ad-hoc manner.

The optimization service 310 requires following components:
a managing component 311, Manager, configured to provide an external client access to the optimization service,
a working component 313, Worker, configured to solve one mathematical optimization at a time,
a messaging component 312, Messaging system, configured to queue optimizations requests for the working components to allow for asynchronous request processing, e.g. the managing component may add an optimization request to the queue when an optimization is triggered and are immediately responsive again and the working component subscribe to the queue to receive incoming requests for optimizations and work on the potentially long-running tasks,
a storage component 314, Database, configured to store meta data for optimization requests, status changes, identifiers, or submission information and solely the managing component reads and writes to this storage component.
in some embodiments, a storage component 315 (not shown), Object Storage, configured to store necessary raw data for the optimization comprising data provided at the time of the submission of the optimization request, debug or intermediate data of the working component and the final optimization solution and wherein both the managing component and the working component reads and writes from.

FIG. 3 illustrates the interactions of clients 1-n with the optimization services 310 and 320 solving different optimization problems. These optimizations services 310 and 320 may be potentially developed by different teams, in different locations using different programming languages. The clients 1-n, e.g. web interfaces or other services, allow users to select data for the optimization, adjust parameters or define an optimization scenario. Each optimization service 310 and 320 may be built specifically for one optimization problem but the micro services architecture 300 is flexible to cater for clients 1-n to access one or multiple optimization services based on their scope.

As illustrated in FIG. 3, the client 301 interfaces with the managing component 311 of an optimization service 310, which is responsible for triggering an optimization, provide its status and solution as well as stop an optimization. The managing component 311 is not solving the actual optimization to avoid blocking for other optimizations. Instead, it queues the optimization requests in a queue, i.e. messaging component, 312 so that the working components 313 can focus on solving optimizations asynchronously. The working components 313 comprise a generic part for sharing functionality across different use-cases and an optimization-specific part for implementing specific models and solution methods. Besides, the working components 313 are responsible to update a request's status and store its solution.

Hence, the micro services architecture 300 comprises at least one optimization service 310, wherein the at least one optimization service comprises a managing component 311 configured to provide access to the at least one optimization service to a client 301, a messaging component 312 configured to queue optimization requests, at least one working component 313 configured to solve optimization tasks, and at least one storage component 314, and wherein the components 311, 312, 313, 314 in the at least one optimization service 310 are operatively connected to each other.

The micro services architecture 300 further comprises a memory comprising executable instructions, one or more processors configured to communicate with the memory, and wherein the one or more processors are configured to cause receipt of, by the managing component 311, an optimization request submitted from the client comprising an optimization task and corresponding data for optimization, storage of, by the managing component 311, the corresponding data for optimization and a created associated identifier of the optimization task in the at least one storage component 314, sending of, by the managing component 311, the optimization task and the associated identifier of the optimization task to the messaging component 312, and monitoring of, by the at least one working component 313, the messaging component 312 for received optimization tasks.

The one or more processors are further configured to cause, at detection, by the at least one working component 313, of a received optimization task, obtainment of, by the at least one working component 313, through the associated identifier of the optimization task the stored corresponding data for optimization from the at least one storage component 314, creation of, by the at least one working component (313), an optimization model to solve the optimization task, solving of, by the at least one working component 313, the optimization task based on the created optimization model, and storage of, by the at least one working component 313, the solution to the optimization task and the associated identifier of the optimization task in the at least one storage component 314.

Hence, scalability, robustness and manageable and small services may be provided as the micro services architecture focuses on small, distributed components that are easy to test, maintain, independently and automatically scalable and manageable by a small team of optimization developers.

FIG. 4 is a schematic block diagram illustrating an example micro services arrangement 400 according to some embodiments. The micro services arrangement 400 is for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other. Thus, the micro services arrangement 400 may, for example, perform the method steps of FIG. 1, the sequence steps of any of FIGS. 2a-2e, and set the states of FIG. 2f for any optimization task submitted to the micro services arrangement 400.

The arrangement 400 comprises device controlling circuitry (CNTR; e.g., a controller or a controlling module) 420, which may in turn comprise (or be otherwise associated with; e.g., connected or connectable to) a receiver 401, e.g. receiving circuitry, configured to receive an optimization request submitted from the client comprising an optimization task and corresponding data for optimization, a storer 404, e.g. storing circuitry, configured to store the corresponding data for optimization and a created associated identifier of the optimization task in a storage 430, and a sender 405, e.g. sending circuitry, configured to send the optimization task and the associated identifier of the optimization task to the messaging component, and a monitor 406, e.g. monitoring circuitry, configured to monitor the messaging component for received optimization tasks.

The CNTR 420 may further comprise (or be otherwise associated with; e.g., connected or connectable to) a detector 407, e.g. detecting circuitry, configured to detect a received optimization task, an obtainer 408, e.g. obtaining circuitry, configured to obtain through the associated identifier of the optimization task the stored corresponding data for optimization from the storage 430, a creator 409, e.g. creating circuitry, configured to create an optimization model to solve the optimization task, a solver 410, e.g. solving circuitry, configured to solve the optimization task based on the created optimization model, and a storer 411, e.g. storing circuitry, configured to store the solution to the optimization task and the associated identifier of the optimization task in the storage 430.

In some embodiments, the CNTR 420 may further comprise (or be otherwise associated with; e.g., connected or connectable to) a determiner 402, e.g. determining circuitry, configured to determine meta data based at least on the submitted optimization request, wherein the meta data comprises submission data of the optimization request.

In some embodiments, the CNTR 420 may further comprise (or be otherwise associated with; e.g., connected or connectable to) a determiner 403, e.g. determining circuitry, configured to determine payload based on the submitted optimization request, wherein the payload comprises the corresponding data for optimization.

The arrangement 400 may further comprise (or be otherwise associated with; e.g., connected or connectable to), a storage 430, e.g. storing circuitry, configured to store the determined meta data and the determined payload.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus comprising arrangements, circuitry, and/or logic according to any of the embodiments described herein. Alternatively or additionally, an electronic apparatus may be configured to perform methods according to any of the embodiments described herein.

According to some embodiments, a computer program product comprises a computer readable medium such as, for example, physical memory. FIG. 5 illustrates an example computer readable medium in the form of physical memory 500 and it is envisaged that the computer readable medium may be any computer readable medium. The computer program product may also include access to a server or a cloud service, the server or cloud service comprising a computer readable medium. The computer readable medium has stored thereon a computer program comprising program instructions. The computer program is loadable into a data processor (PROC) 520, which may, for example, be comprised in electronic apparatus 510. When loaded into the data processing unit, the computer program may be stored in a memory (MEM) 530 associated with or comprised in the data-processing unit. According to some embodiments, the computer program may, when loaded into and run by the data processing unit, cause execution of method and/or sequence steps according to, for example, any of the methods and/or sequences illustrated in FIGS. 1 and 2a-2e or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A computer-implemented method for providing optimization in a micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other, the method comprising the following steps:
receiving, by the managing component, an optimization request submitted from the client comprising an optimization task and corresponding data for optimization,
storing, by the managing component, the corresponding data for optimization and a created associated identifier of the optimization task in the at least one storage component,
sending, by the managing component, the optimization task and the associated identifier of the optimization task to the messaging component,
monitoring, by the at least one working component, the messaging component for received optimization tasks,
at detection by the at least one working component, of a received optimization task:
obtaining, by the at least one working component, through the associated identifier of the optimization task the stored corresponding data for optimization from the at least one storage component,
creating, by the at least one working component, an optimization model to solve the optimization task,
solving, by the at least one working component, the optimization task based on the created optimization model, and
storing, by the at least one working component, the solution to the optimization task and the associated identifier of the optimization task in the at least one storage component.

2. The method according to claim 1, further comprising the following steps:
determining, by the managing component, meta data based at least on the submitted optimization request, wherein the meta data comprises submission data of the optimization request, and
storing, by the managing component, the determined meta data in the at least one storage component, wherein the at least one storage component is accessible to both the managing component and the at least one working component.

3. The method according to claim 1, further comprising the following steps:
determining, by the managing component, payload based on the submitted optimization request, wherein the payload comprises the corresponding data for optimization, and
storing, by the managing component, the determined payload in the at least one storage component, wherein the at least one storage component is accessible to both the managing component and the at least one working component.

4. The method according to claim 1, wherein the at least one storage component comprises a database wherein the database is configured to store meta data or meta data and payload of the optimization request.

5. The method according to claim 1, wherein the at least one storage component comprises two storage components including the database and an object storage, respectively, and wherein the object storage is configured to store the payload of the optimization request.

6. The method according to claim 2, wherein the meta data comprises data for annotating the optimization request.

7. The method according to claim 3, wherein the payload comprises data for optimization corresponding to the optimization request.

8. The method according to claim 1, wherein the architecture comprises a decision support system and/or an optimization system, each system utilizing a cloud infrastructure.

9. The method according to claim 1, wherein the at least one working component is a stateless component.

10. The method according to claim 1, wherein the client is a piece of computer hardware or software configured to access the optimization service.

11. A computer program product comprising a non-transitory computer readable medium, having thereon a computer program comprising program instructions, the computer program being loadable into a data processing unit and configured to cause execution of the method according to claim 1 when the computer program is run by the data processing unit.

12. A micro services architecture for providing optimization, the micro services architecture comprising at least one optimization service, wherein the at least one optimization service comprises a managing component configured to provide access to the at least one optimization service to a client, a messaging component configured to queue optimization requests, at least one working component configured to solve optimization tasks, and at least one storage component, and wherein the components in the at least one optimization service are operatively connected to each other, the architecture further comprising:
a memory comprising executable instructions, one or more processors configured to communicate with the memory, and wherein the one or more processors are configured to cause:
receipt of, by the managing component, an optimization request submitted from the client comprising an optimization task and corresponding data for optimization,
storage of, by the managing component, the corresponding data for optimization and a created associated identifier of the optimization task in the at least one storage component,
sending of, by the managing component, the optimization task and the associated identifier of the optimization task to the messaging component,
monitoring of, by the at least one working component, the messaging component for received optimization tasks,
at detection, by the at least one working component, of a received optimization task:
obtainment of, by the at least one working component, through the associated identifier of the optimization task the stored corresponding data for optimization from the at least one storage component,
creation of, by the at least one working component, an optimization model to solve the optimization task,
solving of, by the at least one working component, the optimization task based on the created optimization model, and
storage of, by the at least one working component, the solution to the optimization task and the associated identifier of the optimization task in the at least one storage component.
